(19) United States
(12) Patent Application Publication
(10) Pub. No.: US 2025/0102396 A1
(43) Pub. Date: Mar. 27, 2025

(54) METHOD AND APPARATUS FOR HANDLING AN OPHTHALMIC LENS AT A TRANSFER STATION OF A LENS INSPECTION MODULE

(71) Applicant: Alcon Inc., Fribourg (CH)

(72) Inventors: Ulrike Rostek, Offenbach (DE); Felix Brinckmann, Roßdorf (DE); Timo Eberle, Kleinwallstadt (DE); Daniel Paulus, Miltenberg (DE)

(21) Appl. No.: 18/889,875

(22) Filed: Sep. 19, 2024

Related U.S. Application Data
(60) Provisional application No. 63/585,388, filed on Sep. 26, 2023.

(51) Int. Cl. G01M 11/02; G02C 13/00

(52) U.S. Cl. CPC G01M 11/0214; G02C 13/001

(57) ABSTRACT

In a method of handling an ophthalmic lens contained in an inspection cuvette and immersed in an inspection liquid the lens is arranged at an actual position relative to a concave inner surface of a bottom glass of the inspection cuvette;

The method comprises the steps of:
positioning the inspection cuvette in a handling position without pivoting the inspection cuvette;
through the viewing glass obtaining an image of the lens;
from the obtained image determining a deviation of the actual position of the lens from a set transfer position;
comparing the deviation with a predetermined maximum deviation;
determining that the lens is arranged at a proper transfer position when the deviation is less than the maximum deviation,
in case of the proper transfer position, transferring the lens from the inspection cuvette to the primary packaging container.

The present invention relates to a method and an apparatus for handling an ophthalmic lens at a transfer station of a lens inspection module, as specified in the respective independent claim.

### BACKGROUND

In the fully automated mass production of ophthalmic lenses, in particular contact lenses such as soft contact lenses, the lenses are automatically inspected as to whether they are compliant with the desired specifications and are free of defects. Inspection of the lenses may be carried out in an inspection module that forms part of the production line in inspection cuvettes. Such inspection cuvettes are known, for example, from WO 2003/016855. Each such inspection cuvette contains an interior space that is filled with an inspection liquid, typically water, and a lens to be inspected is subsequently placed into a respective inspection cuvette filled with the inspection liquid, for example with the aid of a gripper. Inspection of the lens is then performed in the cuvettes with the lens immersed in the inspection liquid.

The inspection cuvette comprises a bottom glass having a concave inner surface that forms a lower boundary of the interior space of the inspection cuvette for the lens to rest on. The inspection cuvette further comprises a flat top viewing glass that forms an upper boundary of the interior space of the inspection cuvette. The flat top viewing glass is arranged such that an optical axis running normal to the flat top viewing glass runs through the center of the concave inner surface of the bottom viewing glass. The cuvette is pivotally arranged between an inspection position (see FIG. 3 of WO 2003/061855) in which the lens is inspected, and a handling position (see FIG. 4 of WO 2003/016855) in which the lens may be placed into and removed from the inspection cuvette.

The inspection cuvette further comprises a handling channel which, at a first end thereof, is connected with the interior space of the inspection cuvette and which, at a second end thereof, comprises a handling opening allowing a gripper to be inserted through the handling channel to the interior of the inspection cuvette, to either place the lens to be inspected into the inspection cuvette or to remove a lens that has successfully passed the inspection from the inspection cuvette.

For inspection of the lens, a lens to be inspected is typically inserted into the cuvette with the aid of a gripper to which the lens adheres. The gripper with the lens adhered thereto is introduced into the inspection cuvette through the handling channel while the inspection cuvette is arranged in the handling position. The lens is then released from the gripper and is allowed to settle down in the inspection liquid to the concave inner surface of the bottom glass. Thereafter, the inspection cuvette is pivoted to the inspection position (see FIG. 3 of WO 2003/061855) in which the lens is inspected through the flat top viewing glass. After inspection, the inspection cuvette is pivoted back to the handling position. In case the lens has successfully passed the inspection, the lens is picked up and removed from the inspection cuvette, and is then transferred to a primary packaging container. Lens pick-up, removal and transfer may be performed with the aid of a transfer gripper. A transfer gripper suitable for this purpose is known, for example, from WO 2020/084573.

This transfer gripper comprises a centrally arranged test vacuum channel (for checking whether or not a lens adheres to the transfer gripper) as well as a plurality of suction openings which extending through the convex distal end of the transfer gripper in the direction of a central longitudinal axis of the transfer gripper. The suction openings are arranged along a circle about and normal to the central longitudinal axis of the transfer gripper. For example, the suction openings are arranged as shown in WO 2020/084573.

For lens pick-up, the transfer gripper is inserted through the handling channel to a predetermined lens-pick up position above the set transfer position of the lens where the lens is ideally expected to be arranged on the concave inner surface of the bottom glass of the inspection cuvette. However, in practice the lens is typically not arranged exactly at the set transfer position, but rather the actual position of the lens on the concave inner surface of the inspection cuvette deviates from the set transfer position. Depending on the deviation of the actual position of the lens from the set transfer position, this may result in that the lens may either not be picked up by the transfer gripper through the application of suction through the suction openings or, in case it is picked up by the transfer gripper, the lens does not adhere to the distal end of the transfer gripper in a centered manner (i.e. such that an axis through the center of the lens coincides with the longitudinal axis of the transfer gripper). In particular, the lens may adhere in a decentered manner to the distal end of the transfer gripper to an extent such that one or more of the suction openings are not covered by the lens adhered to the distal end of the transfer gripper.

As a consequence, at the time the lens is to be released from the transfer gripper in order to be inserted into a primary packaging container, for example by the application of overpressure through the suction openings, the lens may not be properly ‘blown off’ of the transfer gripper so that it may not be placed into the primary packaging container at the desired location of the primary packaging container (e.g. the bowl of the primary packaging container). Rather, due to the decentered adherence of the lens to the distal end of the transfer gripper and the somewhat irregular application of overpressure to the lens through the suction openings (as not all suction openings at the distal end of the transfer gripper are covered by the lens), the lens may be ‘blown off’ of the transfer gripper to either end up at an unwanted location of the primary packaging container (e.g. on the sealing surface of the primary packaging container surrounding the bowl so that it may get sealed between the foil and the primary packing container), or may even end up in the lens packaging module at a location completely outside the primary packaging container. Alternatively, the lens may not be ‘blown off’ of the transfer gripper at all but continues to adhere to the transfer gripper. In such instance, the transfer gripper may pick up the next lens from the cuvette during the next transfer cycle while the lens previously picked up continues to adhere to the transfer gripper so that two lenses may adhere to the transfer gripper. Needless to say, that placement of these two lenses into the packaging container is unwanted, too.

Either case leads to a reduction of the production yield, since at least the respective primary packaging container must be sorted out. In case an arrangement of a plurality of primary packaging containers is commonly sealed by a cover foil (for example, three or five such primary packaging containers) to form a ‘blister strip’ of individual primary packaging containers which are connected to one another, the whole blister strip must be discarded.

Accordingly, it is an object of the instant invention to overcome the afore-mentioned disadvantages and to make sure a lens having successfully passed the inspection is removed from the inspection cuvette and properly placed into the primary packaging container at the desired location thereof (e.g. the bowl), so that always one lens is placed into one primary packaging container at the desired location thereof (e.g. the bowl).

### SUMMARY OF INVENTION

This object is achieved through the method and apparatus according to the instant invention, as specified in the respective independent claim directed to the method and apparatus. Advantageous aspects of the method and apparatus according to the invention are the subject of the dependent claims.

As regards the method according to the invention, this is a method of handling an ophthalmic lens, for example a contact lens such as a soft contact lens, at a transfer station of a lens inspection module where the lens contained in an inspection cuvette and immersed in an inspection liquid is arranged at an actual position relative to a concave inner surface of a bottom glass of the inspection cuvette for being transferred from the inspection cuvette to a primary packaging container. The concave inner surface of the bottom glass forms a lower boundary of an interior space of the inspection cuvette. The inspection cuvette further comprises a flat top viewing glass forming an upper boundary of the interior space of the inspection cuvette, the flat top viewing glass being arranged such that an optical axis running normal to the flat top viewing glass runs through the center of the concave inner surface of the bottom viewing glass. The inspection cuvette is pivotally arranged between an inspection position for inspecting the lens, and a handling position in which the lens may be inserted into and removed from the interior space of the inspection cuvette. The inspection cuvette further comprises a handling channel which is connected at a first end thereof with the interior space and at a second end thereof comprises a handling opening allowing a transfer gripper to be inserted through the handling channel to a predetermined lens pick-up position above a predetermined set transfer position of the lens when the cuvette is in the handling position.

The method according to the invention comprises the steps of:
positioning the inspection cuvette in the handling position without subsequently pivoting the inspection cuvette anymore;
through the viewing glass obtaining, along the optical axis, an image of the lens arranged at the actual position relative to the concave inner surface of the bottom glass;
from the so obtained image of the lens at the actual position determining a deviation of the actual position of the lens from the predetermined set transfer position;
comparing the deviation of the actual position of the lens from the predetermined set transfer position with a predetermined maximum deviation;
determining that the lens is arranged at a proper transfer position when the deviation of the actual position from the predetermined set transfer position is less than the predetermined maximum deviation,
otherwise determining that the lens is not arranged at the proper transfer position; and
in case the lens is determined to be arranged at the proper transfer position, transferring the lens from the inspection cuvette to the primary packaging container,
in case the lens is determined not to be arranged at the proper transfer position, not transferring the lens from the inspection cuvette to the primary packaging container.

In case the lens is determined to be arranged at the proper transfer position, according to one aspect the method according to the invention may further comprise the steps of
inserting a transfer gripper through the handling channel to the predetermined lens pick-up position;
picking the lens up at the proper transfer position by the transfer gripper to make the lens adhere to the transfer gripper;
removing the transfer gripper with the lens adhered thereto from the inspection cuvette and moving it to the primary packaging container,
releasing the lens from the transfer gripper into the primary packaging container.

In case the lens is determined not to be arranged at the proper transfer position, according to a further aspect the method according to the invention may further comprise the steps of
leaving the lens in the inspection cuvette and
removing the lens together with the inspection liquid from the inspection cuvette by sucking the lens and liquid out of the interior space of the inspection cuvette.

According to a further aspect of the method according to the invention, the deviation of the actual position of the lens from the predetermined set transfer position may be determined by determining a value representative of the eccentricity of the actual position of the lens relative to the predetermined set transfer position.

Still in accordance with a further aspect of the method according to the invention, the lens may be determined to be arranged at the proper transfer position in case the eccentricity of the actual position of the lens relative to the predetermined set transfer position is less than a predetermined threshold eccentricity, otherwise the lens may be determined not to be at the proper transfer position.

Yet in accordance with a further aspect of the method according to the invention, the threshold eccentricity may be determined according to the equation

$${e}_{t} = [ {r}_{L} - ( {r}_{T} + {r}_{B} ) ]$$

wherein
r_{L} denotes the radius (half the diameter) of the circumferentially running lens edge;
r_{B} denotes the radius (half the diameter) of the suction openings extending through the convex distal end of the transfer gripper in a direction of a central longitudinal gripper axis;
r_{T} denotes the radius of a circle extending about the central longitudinal gripper axis and normal thereto, with the suction openings in the convex distal end of the transfer gripper being arranged along the said circle, and
eₜ denotes the threshold eccentricity.

As regards the apparatus according to the invention, this is an apparatus for handling an ophthalmic lens, for example a contact lens such as a soft contact lens, at a transfer station of a lens inspection module where the lens contained in an inspection cuvette and immersed in an inspection liquid is arranged at an actual position relative to a concave inner surface of a bottom glass of the inspection cuvette for being transferred from the inspection cuvette to a primary packaging container. The concave inner surface of the bottom glass forms a lower boundary of an interior space of the inspection cuvette. The inspection cuvette further comprises a flat top viewing glass forming an upper boundary of the interior space of the cuvette. The flat top viewing glass is arranged such that an optical axis running normal to the flat top viewing glass runs through the center of the concave inner surface of the bottom glass. The inspection cuvette is pivotally arranged between an inspection position for inspecting the lens, and a handling position in which the lens may be inserted into and removed from the interior space of the inspection cuvette. The inspection cuvette further comprises a handling channel which is connected at a first end thereof with the interior space and at a second end thereof comprises a handling opening allowing a transfer gripper to be inserted through the handling channel to a predetermined lens pick-up position above a predetermined set transfer position of the lens when the inspection cuvette is in the handling position.

The apparatus according to the invention comprises:
a camera arranged along the optical axis for recording, through the viewing glass, an image of the lens at the actual position relative to the concave inner surface of the bottom glass of the inspection cuvette when the inspection cuvette is in the handling position and is subsequently not pivoted anymore;
a processor configured to
   from the image of the lens at the actual position determine a deviation of the actual position of the lens from the predetermined set transfer position of the lens;
   compare the deviation of the actual position of the lens from the set transfer position with a predetermined maximum deviation;
   determine that the lens is arranged at a proper transfer position when the deviation is less than the predetermined maximum deviation, otherwise determine that the lens is not arranged at the proper transfer position, and
   in case the lens is determined to be arranged at the proper transfer position, generate a signal triggering the transfer of the lens from the inspection cuvette to the primary packaging container,
   in case the lens is determined not to be arranged at the proper transfer position, generate a signal preventing the transfer of the lens from the inspection cuvette to the primary packaging container.

According to one aspect, the apparatus according to the invention may further comprise a transfer gripper arranged to be inserted into and removed from the interior space of the inspection cuvette through the handling channel to the predetermined lens pick-up position after receipt of the signal triggering the transfer of the lens, for picking the lens up at the proper transfer position to make the lens adhere to the transfer gripper, for removing the lens adhered to the transfer gripper from the inspection cuvette, for moving the gripper with the lens adhered thereto to the primary packaging container, and for releasing the lens from the transfer gripper into the primary packaging container.

According to a further aspect, the apparatus according to the invention may further comprise a suction tube arranged to be inserted into the interior space of the inspection cuvette through the handing channel to a predetermined sucking position, for sucking the inspection liquid and the lens out of the inspection cuvette after receipt of the signal preventing the transfer of the lens from the inspection cuvette to the primary packaging container, and for sucking the inspection liquid out of the inspection cuvette after receipt of the signal triggering the transfer of the lens and removal of the lens from the inspection cuvette.

According to still a further aspect of the apparatus according to the invention, the processor may be configured to determine a value representative of the eccentricity of the actual position of the lens relative to the predetermined set transfer position to determine the deviation of the actual position of the lens relative to the set transfer position.

According to yet another aspect of the apparatus according to the invention, the processor may be configured to determine that the lens is at the proper transfer position in case the eccentricity of the actual position of the lens relative to the predetermined set transfer position is less than a predetermined threshold eccentricity, and to otherwise determine that the lens is not at the proper transfer position.

According to a further aspect of the apparatus according to the invention, the processor may be configured to determine the threshold eccentricity according to the equation

$${e}_{t} = [ {r}_{L} - ( {r}_{T} + {r}_{B} ) ]$$

wherein
r_{L} denotes the radius (half the diameter) of the lens;
r_{B} denotes the radius (half the diameter) of the suction openings that extend through the convex distal end of the transfer gripper in a direction of a central longitudinal gripper axis;
r_{T} denotes the radius of a circle extending about the central longitudinal gripper axis and normal thereto, with the suction openings in the convex distal end of the transfer gripper being arranged along the said circle, and
e denotes the eccentricity.

The method and apparatus according to the invention offer a number of advantages. The most significant advantage is that at the time the image of the lens in the inspection cuvette is obtained (with the aid of a camera) through the flat top viewing glass, the inspection cuvette is in the handling position in which the lens may be removed from the inspection cuvette through the handling channel (with the aid of a suitable transfer tool) and transferred to the primary packaging container. And while this includes cases in which the inspection cuvette may still be transported horizontally, the inspection cuvette is not pivoted anymore after the image of the lens has been obtained so that the position of the lens relative to the bottom glass of the cuvette practically does not change anymore, so that at the transfer station the exact position of the lens in the inspection cuvette is known.

Before starting lens production (including lens inspection in the inspection module), an exact positioning of the inspection cuvettes on their associated transportation carriers is performed to make sure the individual inspection cuvettes are always arranged in the same exact position relative to their associated transfer tool at the transfer station of the inspection module. The transfer tool—typically a transfer gripper—is always arranged at the same position in the transfer station of the inspection module when it is ready to remove a lens from the inspection cuvette, and is always moved downwards into the inspection cuvette through the handling channel of the inspection cuvette to the same predetermined lens pick-up position to pick a lens up. This predetermined lens pick-up position of the transfer gripper is exactly defined relative to a predetermined set transfer position of the lens in the inspection cuvette at which the lens is ideally positioned when the inspection cuvette is arranged at the transfer station of the lens inspection module, as the inspection cuvettes are always arranged in the same exact position relative to their associated transfer gripper. Accordingly, once the position of the lens relative to the set transfer position has been determined in the image of the lens in the inspection cuvette, the position of the lens relative to the lens-pick up position of the transfer gripper at the transfer station of the inspection module is also known.

In practice, the lens is only extremely rarely arranged exactly at the desired set transfer position. Instead, the actual position of the lens deviates from the set transfer position. As the present invention allows to determine, from the image of the lens in the inspection cuvette obtained with the camera, the deviation of the actual position of the lens from the set transfer position, this also allows to determine the displacement of the lens relative to the lens-pick up position of the transfer gripper. This determination is made with the aid of a processor which may be an integral component of the camera or may be a component separate from the camera, for example of a separate image analysis device). Once the deviation of the actual lens position from the set transfer position is determined, this allows for making a determination whether or not the lens may be safely picked up by the transfer gripper, removed from the inspection cuvette adhered to the transfer gripper, transferred to the primary packaging container and safely placed into the primary packaging container at the desired location thereof (e.g. into the bowl of the primary packaging container). In case the deviation of the actual position of the lens from the set transfer position is less than a predetermined maximum deviation, the lens is determined to be arranged at a proper transfer position. Otherwise it is determined that the lens is not arranged at a proper transfer position.

In the first case (lens arranged at a proper transfer position), a signal is generated by the processor triggering the transfer of the lens from the inspection cuvette to the primary packaging container. In the second case (lens not arranged at a proper transfer position), a signal is generated by the processor preventing the transfer from the inspection cuvette to the primary packaging container. The result is an increased rate of successful lens transfers and prevents lenses from ending up at an unwanted location of the primary packaging container (e.g. on the sealing surface) or at an unwanted location of the primary packaging module, as only lenses are transferred for which a safe transfer of the lens (including placement in the primary packaging container at the desired location).

Determination of whether or not the lens is arranged at a proper transfer position may be achieved by the processor determining a value representative of the eccentricity of the actual position of the lens relative to the predetermined set transfer position. The term ‘eccentricity’ is to be understood to denote the distance of the center of the lens in its actual position relative to the predetermined set transfer position where the lens is ideally arranged. When the eccentricity is used to make the determination whether or not the lens is in the proper transfer position, then the eccentricity determined must be smaller than a threshold eccentricity to determine that the lens is in the proper transfer position. Otherwise the lens is determined not to be in the proper transfer position.

In particular, the threshold eccentricity may be determined by the processor according to the equation

$${e}_{t} = [ {r}_{L} - ( {r}_{T} + {r}_{B} ) ]$$

wherein
r_{L} denotes the radius (half the diameter) of the lens;
r_{B} denotes the radius (half the diameter) of the suction openings extending through the convex distal end of the transfer gripper in a direction of a central longitudinal gripper axis;
r_{T} denotes the radius of a circle extending about the central longitudinal gripper axis and normal thereto, with the suction openings in the convex distal end of the transfer gripper being arranged along the said circle, and
eₜ denotes the threshold eccentricity.

The afore-mentioned equation for the threshold eccentricity (eₜ) contains parameters of the transfer gripper (r_{B}, r_{T}) which are known to the processor and cannot be derived from the image of the lens obtained with the aid of the camera. However, the radius n (half the diameter) of the lens that has a circular circumferentially running lens edge may be determined from the image of the lens obtained with the aid of the camera in any conventional manner known in the art. Once the parameters n, r and IT are known, the threshold eccentricity eₜ can be determined by the processor using the above-mentioned equation, and the comparison of the eccentricity of the actual position of the lens (determined with the aid of the camera) with the threshold eccentricity can be performed to determine whether or not the lens is in a proper transfer position.

Regardless of the method how it is determined whether or not the lens is arranged in the proper transfer position, in case the lens is determined to be in the proper transfer position, after receipt of the signal from the processor triggering the transfer of the lens from the inspection cuvette to the primary packaging container, the transfer gripper is inserted into the interior space of the inspection cuvette through the handling channel to pick the lens up and make it adhere to the transfer gripper. After picking the lens up and making it adhere to the transfer gripper (e.g. through the application of suction through the suction openings extending through the distal end of the transfer gripper in the direction of the central longitudinal axis of the transfer gripper), the transfer gripper is removed from the inspection cuvette through the handling channel with the lens adhered to the transfer gripper. The transfer gripper with the lens adhered thereto is then moved (from the transfer station of the inspection module) to the primary packaging container (arranged in the primary packaging module) where the lens is released from the transfer gripper into the primary packaging container (e.g. by blowing the lens off of the transfer gripper through the application of overpressure through the suction openings extending through the distal end of the transfer gripper). Thereafter, the application of overpressure is terminated and the transfer gripper is moved back to the transfer station to pick the next lens up.

Downstream of the transfer station on the return path of the inspection cuvettes to a lens insertion station at which the next lens to be inspected is inserted into the inspection cuvette filled with fresh inspection liquid, e.g. water, a suction tube is inserted into the inspection cuvette. In case the lens has been transferred from the inspection cuvette to the primary packaging container only the inspection liquid is sucked out of the inspection cuvette. However, in case it has been determined that the lens is not in a proper transfer position, after receipt of the signal from the processor preventing the transfer of the lens from the inspection cuvette to the primary packaging container, the lens may be left in the inspection cuvette and the transfer gripper is not inserted into the inspection cuvette at the transfer station of the inspection module to remove the lens from the inspection cuvette. In such case, not only the inspection liquid is sucked out of the inspection cuvette by the suction tube, but rather the lens that has been left in the inspection cuvette is sucked out of the inspection cuvette together with the inspection liquid and is then separated from the inspection liquid.

### BRIEF DESCRIPTION OF THE DRAWINGS

Further advantageous aspects of the method and apparatus become apparent from the following description of embodiments of the invention with the aid of the schematic drawings in which:

FIG. 1 shows some essential components of an embodiment of the apparatus according to the invention, with an inspection cuvette arranged in the handling position at the lens transfer station of a lens inspection module, and with the inspection cuvette containing a lens arranged at the set transfer position ready for being picked up by a transfer gripper;

FIG. 2 shows an enlarged view of the inspection cuvette shown in FIG. 1 and the transfer gripper;

FIG. 3 shows an enlarged view of the inspection cuvette and the transfer gripper shown in FIG. 2, with the lens being arranged in a proper transfer position, but slightly displaced (eccentric) relative to the set transfer position;

FIG. 4 shows an enlarged view of the inspection cuvette and the transfer gripper shown in FIG. 2, with the lens not being arranged in a proper transfer position, but substantially displaced (eccentric) relative to the set transfer position;

FIG. 5 shows a transfer gripper with a lens having been picked up from the set transfer position and adhered to the distal end of the transfer gripper;

FIG. 6 shows an enlarged view of detail VI of FIG. 5;

FIG. 7 shows a transfer gripper with a lens virtually having been picked up from the substantially displaced (eccentric) position in which the lens is actually not picked up in accordance with the invention;

FIG. 8 shows an enlarged view of the detail VIII of FIG. 7;

FIG. 9 shows a further enlarged view of a detail of FIG. 8 to explain the determination of the threshold eccentricity;

FIG. 10 shows a schematic view further explaining the determination of the actual eccentricity of the position of the lens from the image obtained with the camera, and

FIG. 11 shows an enlarged view of the inspection cuvette from which the lens has not been transferred, and with a suction tube inserted through the handling channel for sucking the lens and liquid out of the inspection cuvette.

### DETAILED DESCRIPTION OF EMBODIMENTS

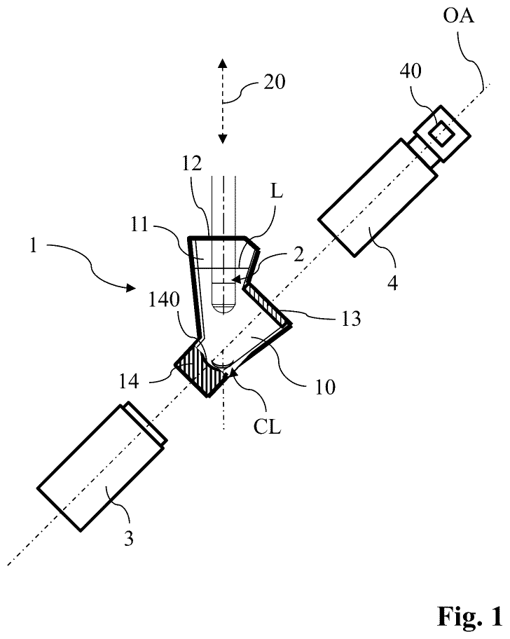

FIG. 1 shows some essential components of an embodiment of the apparatus according to the invention. An inspection cuvette 1 filled with an inspection liquid L, for example water, is arranged in the handling position, as this is the case at a lens transfer station of a lens inspection module at which a lens may be removed from inspection cuvette 1 and transferred to a primary packaging container. Inspection cuvette 1 comprises a bottom glass 14 having a concave inner surface 140 that forms a lower boundary of an interior space 10 of inspection cuvette 1, for a contact lens CL to rest on during lens inspection. Inspection cuvette 1 further comprises a flat top viewing glass 13 that forms an upper boundary of interior space 10. Inspection cuvette 1 is pivotally arranged between an inspection position and a handling position.

In the inspection position (in which a normal on top viewing glass 13 runs vertically, not shown in FIG. 1) a soft contact lens CL immersed in inspection liquid L may be inspected through top viewing glass 13 for defects, optical and geometrical parameters, orientation (right side up or upside down), inversion state (non-inverted or inverted), etc., whereas in the handling position (shown in FIG. 1) soft contact lens CL may be inserted into interior space 10 of inspection cuvette 1 or may be removed therefrom. For the latter purpose (i.e. insertion or removal of soft contact lens CL), inspection cuvette 1 comprises a handling channel 11 that is connected at a first end thereof with interior space 10, and at a second end thereof comprises a handling opening 12. In the handling position shown in FIG. 1, insertion of soft contact lens CL into the interior space 10 of inspection cuvette 1 as well as removal of soft contact lens CL from interior space 10 may be performed through the said handling channel 11 of inspection cuvette 1, as is indicated in FIG. 1 by the double-headed arrow 20. In this regard, it should be mentioned that both insertion of the soft contact lens CL into and removal of the soft contact lens CL from the interior space 10 of inspection cuvette 1 is typically performed with the aid of grippers. However, the gripper for insertion of soft contact lens CL into inspection cuvette 1 (this gripper not being shown in FIG. 1) and the transfer gripper 2 (shown in FIG. 1) for transferring soft contact lens CL from inspection cuvette 1 to a primary packaging container are typically different from one another from a constructional point of view.

As can further be seen in FIG. 1, the position of the soft contact lens CL (at least partly) on concave inner surface 140 of inspection cuvette 1 is determined with the aid of an image thereof, and for obtaining such image a light source 3 may be arranged beneath bottom glass 14 for illumination and a camera 4 may be arranged above top viewing glass 13 for capturing the image along an optical axis OA.

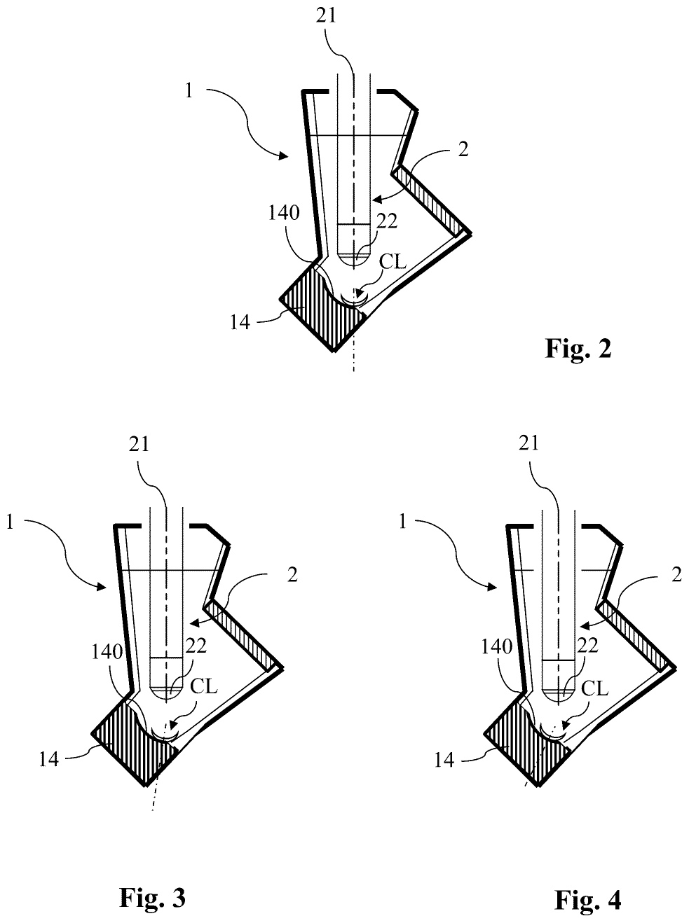

In the following, three different scenarios of how the soft contact lens CL is arranged in inspection cuvette 1 at the time soft contact lens CL is to be transferred from inspection cuvette 1 to a primary package are discussed in the following with the aid of FIG. 2, FIG. 3 and FIG. 4. Each of FIG. 2, FIG. 3 and FIG. 4 shows an enlarged view of the inspection cuvette shown in FIG. 1 and the transfer gripper 2 as well as the soft contact lens CL, however, in each of these scenarios soft contact lens CL is arranged differently.

FIG. 2 shows soft contact lens CL arranged at an actual position relative to concave inner surface 140 of bottom glass 14 of inspection cuvette 1, and this actual position of soft contact lens CL corresponds to a predetermined (desired) set transfer position at which soft contact lens CL is ideally positioned for being transferred. This actual position of soft contact lens CL is extremely rare in practice, but for the sake of better understanding the invention the transfer of soft contact lens CL from this set transfer position is shortly discussed in the following. As is already mentioned further above, at the transfer station of the inspection module (of the production line) transfer gripper 2 is always arranged at the same position (x,y,z) relative to the respective inspection cuvette 1 that is actually present at the transfer station, and this position of transfer gripper 2 is set for a soft contact lens CL that is arranged in the desired set transfer position (i.e. the position shown in FIG. 2). Transfer gripper 2 comprises a central longitudinal gripper axis 21. With soft contact lens CL being in the set transfer position, transfer gripper 2 is lowered (in the direction of central longitudinal gripper axis 21) until the convex distal end of transfer gripper 2 is arranged only a small distance above soft contact lens CL to pick soft contact lens CL up by applying suction through a suction supply channel of transfer gripper 2 and thus making soft contact lens CL adhere to the convex distal end of transfer gripper 2. Transfer gripper 2 with soft contact lens CL adhered to its convex distal end is then raised (again in the direction of central longitudinal gripper axis 21), thus removing soft contact lens CL from inspection cuvette 1. Thereafter, transfer gripper 2 is moved to a primary packaging station where a primary packaging container is waiting. Soft contact lens CL is then released from convex distal end 22 of transfer gripper 2 into the primary packaging container (e.g. by terminating the supply of suction through the suction supply channel and by applying overpressure through an overpressure supply channel instead), as is explained in more detail below.

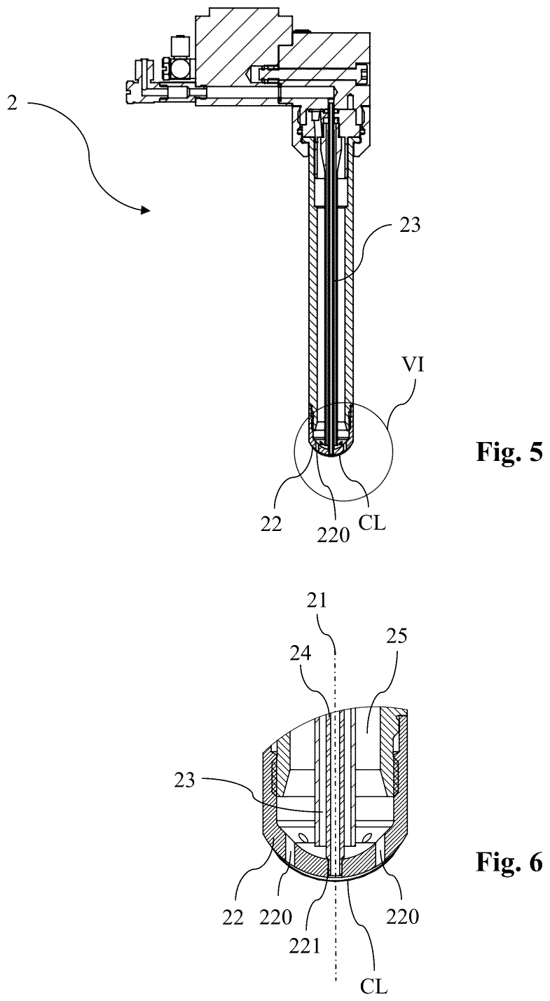

FIG. 5 shows a more detailed view of an embodiment of transfer gripper 2 with contact lens CL adhered to the convex distal end 22 thereof once it has been picked up from the set transfer position shown in FIG. 2. To make soft contact lens CL adhere to convex distal end 22, suction is applied through a suction supply channel 23 of transfer gripper 2. The suction applied through suction supply channel 23 is further supplied through suction openings 220 arranged in the convex distal end 22 of transfer gripper 2. Suction openings 220 extend in the direction of central longitudinal gripper axis 21 (i.e. parallel to or coincident with longitudinal gripper axis 21, here: parallel to) through convex distal end 22 of transfer gripper 2, and which are arranged along a circle that extends about central longitudinal gripper axis 21 and normal thereto. Thus, soft contact lens CL is sucked against and adheres to convex distal end 22 of transfer gripper 2.

FIG. 6 shows detail VI of FIG. 5 in an enlarged view. From this enlarged view it is evident that soft contact lens CL adheres to convex distal end 22 of transfer gripper 2 in a perfectly centered manner, with all suction openings 220 of convex distal end 22 being completely covered by soft contact lens CL. This is because soft contact lens CL has been picked up from the desired set transfer position. This scenario represents the ideal case in which soft contact lens CL is safely picked up and removed from concave surface 140 of bottom glass 14 of inspection cuvette 1. Once transfer gripper 2 with soft contact lens CL adhered thereto has been moved to the primary packaging container and has reached the release position in which soft contact lens CL is to be released into the primary packaging container, suction is no longer supplied through suction supply channel 23 and suction openings 220. Instead, overpressure is then applied through overpressure supply channel 25 and further through suction openings 220 in convex distal end 22 of transfer gripper 2, thus releasing soft contact lens CL from convex distal end 22 of transfer gripper 2.

As can be seen in FIG. 6, the shown embodiment of transfer gripper 2 further comprises a centrally arranged test vacuum tube 24 the end of which is arranged in a pressure-tight manner in a central opening 221 that also extends through convex distal end 22 of transfer gripper 2, again in the direction of longitudinal gripper axis 21 (here: coincident therewith). A test vacuum may be supplied through centrally arranged test vacuum tube 24 (separated from the suction applied through suction supply channel 23 and the overpressure supplied through the overpressure supply channel 25). This test vacuum supplied through centrally arranged test vacuum tube 24 may serve two purposes. The first purpose is to determine whether a soft contact lens CL adheres to convex distal end 22 during lens transfer. The second purpose is to check, on the return path of transfer gripper 2 back to the position for being ready for the next lens pick-up, whether soft contact lens CL has indeed been released from convex distal end 22 of transfer gripper 2. This check is performed to avoid that—for whatever reason—inadvertently soft contact lens CL has not been released from convex distal end 22 of transfer gripper 2 but still adheres thereto at the time transfer gripper 2 is to pick up the next lens. So far transfer gripper 2 and its mode of operation is known from and described in WO 2020/084573.

Turning back to FIG. 3, an enlarged view of inspection cuvette 1 and transfer gripper 2 is shown there. As can be seen in FIG. 3 soft contact lens CL is not arranged at the (ideal) set transfer position shown in FIG. 2, but is slightly displaced (eccentric) relative to the set transfer position so that the deviation of the actual position of soft contact lens CL relative to concave bottom surface 140 of bottom glass 14 of inspection cuvette 1 from the set transfer position of soft contact lens CL relative to concave bottom surface 140 of bottom glass 14 of inspection cuvette 1 (see FIG. 2) is less than a predetermined maximum deviation. Since in the scenario shown in FIG. 3 this deviation is only small and in particular less than the predetermined maximum deviation, soft contact lens CL is determined to be arranged at a proper transfer position in which it can be safely picked up and removed from inspection cuvette 1 by transfer gripper 2 in the manner described above, and thereafter be transferred to the primary packaging container.

In contrast thereto, FIG. 4 shows an enlarged view of inspection cuvette 1 and transfer gripper 2 shown in FIG. 2, with soft contact lens CL being very substantially displaced (eccentric) relative to the set transfer position so that the deviation of the actual position of soft contact lens CL relative to concave bottom surface 140 of bottom glass 14 of inspection cuvette 1 from the set transfer position of soft contact lens CL relative to concave bottom surface 140 of bottom glass 14 of inspection cuvette 1 is no longer less than the predetermined maximum deviation. Due to the substantial displacement of soft contact lens CL and in particular due to the deviation no longer being less than the predetermined maximum deviation, soft contact lens CL is determined not to be arranged at a proper transfer position so that it may not be picked up and removed from inspection cuvette 1 by transfer gripper 2 in the manner described above, as well as transferred to the primary packaging container with sufficient certainty.

In the scenarios shown in FIG. 2 and FIG. 3, soft contact lens CL is actually transferred from inspection cuvette 1 to primary packaging container, whereas in the scenario shown in FIGS. 4 in accordance with the invention no transfer of soft contact lens CL is performed. To initiate or prevent transfer of soft contact lens CL, a processor 40 which may either form an integral part of camera 4 (see FIG. 1) or which alternatively may be a processor separate from the camera 4, may generate a signal triggering the transfer of soft contact lens CL with the aid of transfer gripper 2 or may generate a signal preventing the transfer of soft contact lens CL with the aid of transfer gripper 2, depending on whether or not it has been determined that the soft contact lens CL is arranged at a proper transfer position.

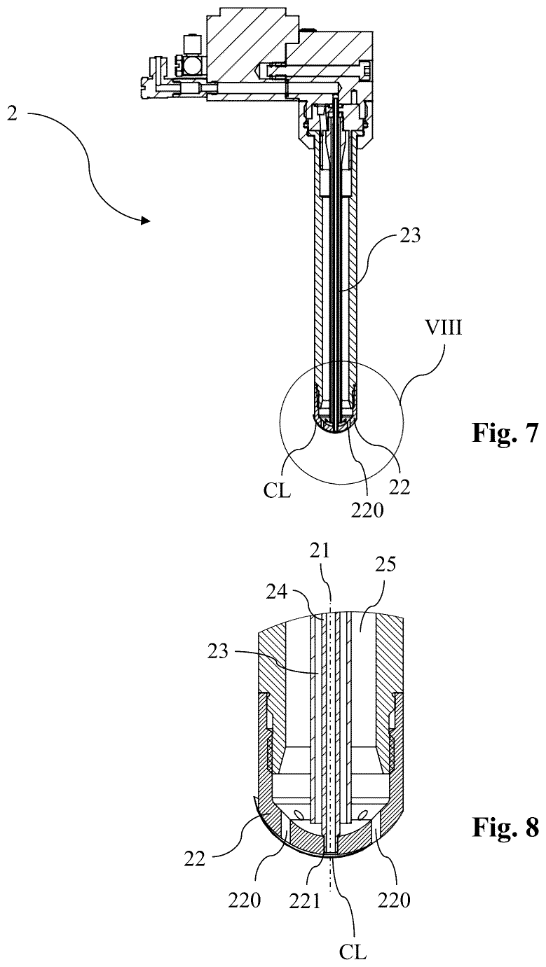

FIG. 7 shows a more detailed view of an embodiment of transfer gripper 2 (similar to FIG. 5) with soft contact lens CL adhered to the convex distal end 22 thereof to illustrate what may happen in case soft contact lens CL had been picked up from the transfer position shown in FIG. 4 (which does not occur in accordance with the invention). Due to the substantial displacement of soft contact lens CL from the set transfer position and in particular due to the deviation of the actual position of soft contact lens CL from the set transfer position no longer being less than the predetermined maximum deviation, soft contact lens CL may either not be safely picked up and removed from inspection cuvette 1 by transfer gripper 2 in the manner described above, or may not be safely transferred to the primary packaging container.

As describe above, to make soft contact lens CL adhere to convex distal end 22 of transfer gripper 2, suction is applied through suction supply channel 23 of transfer gripper 2. The suction applied through suction supply channel 23 is further supplied through suction openings 220 arranged in the convex distal end 22 of transfer gripper 2.

FIG. 8 shows detail VIII of FIG. 7 in an enlarged view. From this enlarged view it is evident that soft contact lens CL adheres to convex distal end 22 of transfer gripper 2 in a substantially decentered manner. In particular, some of the suction openings 220 of convex distal end 22 are no longer covered by soft contact lens CL. This may lead to air being sucked in through those suction openings 220 which are not covered by soft contact lens CL, and thus may lead to a reduction of the suction applied to soft contact lens CL. As a consequence, it may occur that soft contact lens CL may inadvertently get released from convex distal end 22 of transfer gripper 2 so that it may not be properly transferred to the primary packaging container. Even assuming that soft contact lens CL adheres to transfer gripper 2 until transfer gripper 2 has reached the release position at which soft contact lens CL is to be released from convex distal end 22 of transfer gripper 2 into the primary packaging container, the release of soft contact lens CL into the primary packaging container may not be performed with sufficient certainty. As is described above, once transfer gripper 2 has reached the release position in which soft contact lens CL is to be released into the primary packaging container, suction is no longer supplied through suction supply channel 22 and suction openings 220, and overpressure is applied through overpressure supply channel 25 instead. This overpressure is then further supplied through suction openings 220 in the convex distal end 22 of transfer gripper 2. Due to the decentered adherence of soft contact lens CL to convex distal end 22, the overpressure supplied through overpressure supply channel 25 may not be applied in the same uniform manner to soft contact lens CL as some of the suction openings 220 are not covered by soft contact lens CL. This may result in that soft contact lens CL may not be properly placed into the primary packaging container (i.e. into the bowl thereof), but instead soft contact lens may be placed on the sealing area of the shell of the primary packing container so that it may get sealed between the cover foil and the shell, or it may end up at another unwanted location in the primary packaging module. As typically a plurality of such packaging containers are connected through the foil to form a blister strip, the blister strip is sorted out and cannot be distributed, thus leading to a decrease of the production yield.

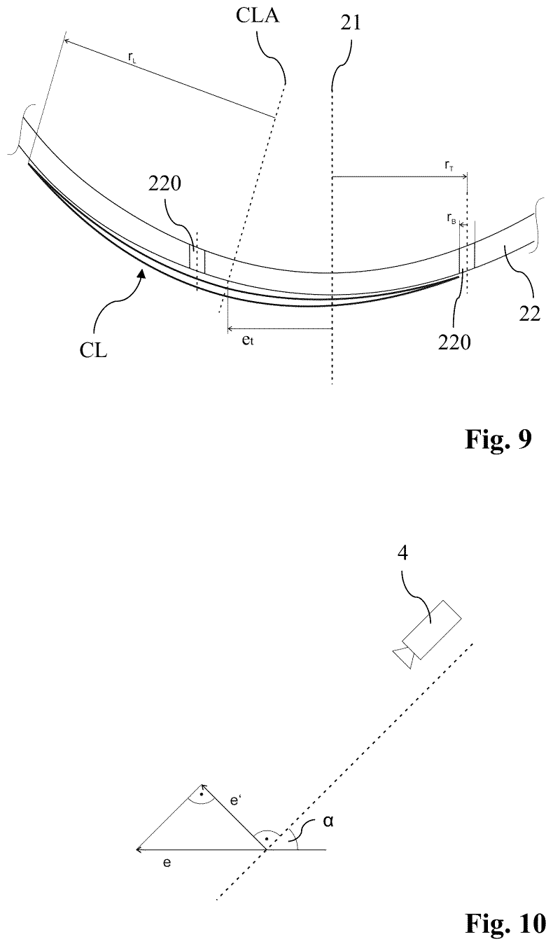

In the following, an embodiment of how the determination whether or not soft contact lens CL is arranged at a proper transfer position may be made is explained in the following with the aid of FIG. 9 and FIG. 10. And although soft contact lens CL is arranged on concave inner surface 140 of bottom glass 14 of inspection cuvette 1 during lens pick-up, the following explanation refers to soft contact lens CL and its position relative to convex distal end 22 of transfer gripper 2. This is possible since the position of convex distal end 22 of transfer gripper 2 is exactly known relative to concave inner surface 140 of bottom glass 14 of the respective inspection cuvette 1 when transfer gripper 2 has been moved to the lens pick-up position through handling channel 11 of inspection cuvette 1 (as all inspection cuvettes 1 are exactly moved to the same position relative to transfer gripper 2 in the inspection module). For the sake of better understanding, let us assume that the concave inner surface 140 of bottom glass 14 of inspection cuvette 1 (not shown in FIG. 9) is arranged right beneath soft contact lens CL and soft contact lens CL rests on the said concave inner surface 140 at the time it is picked up by transfer gripper 2 to adhere to convex distal end 22 thereof.

FIG. 9 shows a scenario where soft contact lens CL is arranged at an actual position at which at least one (one or more) of the suction openings 220 is just no longer partly covered by soft contact lens CL when adhered to convex distal end 22 of transfer gripper 2. In FIG. 9, suction opening 220 shown at the right-hand side is just no longer partly covered by soft contact lens CL.

As can further be seen from FIG. 9, n denotes the radius (half the diameter) of soft contact lens CL, while r_{B} denotes the radius (half the diameter) of suction openings 220. In addition, r_{T} denotes the radius of a circle that extends about central longitudinal axis 21 and normal thereto, and along this circle the suction openings 220 are arranged. More precisely, the suction openings 220 are arranged along this circle such that the longitudinal axes of the suction openings 220 which are arranged parallel to central longitudinal axis 21 intersect the said circle having the radius IT.

The eccentricity e (see FIG. 10) represents the deviation of the actual position of soft contact lens CL from the (ideal) set transfer position of soft contact lens CL (see FIG. 2, FIG. 5 and FIG. 6). The eccentricity e is the radial distance between that location where the central longitudinal axis 21 intersects the outer surface of convex distal end 22 of transfer gripper 2 and the location where the central lens axis CLA through soft contact lens CL intersects the outer surface of convex distal end 22 of transfer gripper 2, when transfer gripper 2 is in the lens pick-up position. FIG. 9 now shows the threshold eccentricity eₜ which is the smallest eccentricity that is not admissible anymore, as a thus arranged soft contact lens CL may not be picked-up and transferred to the primary packaging container with sufficient certainty.

The afore-mentioned threshold eccentricity eₜ is determined according to the equation:

$${e}_{t} = [ {r}_{L} - ( {r}_{T} + {r}_{B} ) ]$$

with
r_{L} denoting the radius (half the diameter) of the soft contact lens CL,
r_{B} denoting the radius (half the diameter) of the suction openings 220, and
r_{T} denoting the radius of the circle along which the suction openings 220 are arranged, as has been explained above.

As the image of soft contact lens CL arranged on inner surface 140 of bottom glass 14 of inspection cuvette 1 is captured (taken) along an optical axis arranged at an obtuse angle α relative to the central longitudinal axis 21 of transfer gripper 2, for example at an angle α=45° (degrees) as shown in FIG. 10, it is to be considered that the angle at which the image is captured must be taken into account when determining whether or not the eccentricity of the actual position of soft contact lens is less than the threshold eccentricity eₜ. Or to say it in other words, this angle α must be taken into account when determining whether or not soft contact lens CL is in a proper transfer position.

That is, in the image of soft contact lens CL and inner surface 140 of bottom glass 14 of inspection cuvette 1 taken by camera 4 a virtual eccentricity e′ is actually contained. The true eccentricity e, however, is determined from the virtual eccentricity e′ by dividing the virtual eccentricity e′ contained in the image by the cosine of the angle α at which the image is obtained (see above).

To say it in terms of an equation, this means: e=e′/cos α; or e′=e·cos α

In particular for an angle α of 45° (degrees), this means:

$$e = {e}^{′} / ( 1 / 2 \cdot √ 2 ) = {e}^{′} \cdot √ 2 , or {e}^{′} = e / √ 2$$

Once it is determined whether or not soft contact lens CL is in a proper transfer position, either transfer of soft contact lens CL is triggered and performed (lens in a proper transfer position) or transfer of soft contact lens CL is prevented (lens not in a proper transfer position). As has already been mentioned above, this determination is made for example with the aid of a processor 40 which may be an integral part of camera 4 (see FIG. 1) or which is a processor separate from camera 4 (not shown).

Transfer of soft contact lens CL with the aid of transfer gripper 2 has already been explained above and is therefore not reiterated. However, in case soft contact lens CL is determined not to be in a proper transfer position, there is no lens transfer. Soft contact lens CL may then be left in inspection cuvette 1, i.e. no attempt is made at the transfer station to remove it from inspection cuvette 1. Rather, on the return path of the inspection cuvettes 1 back to the lens insertion station of the inspection module, soft contact lens CL may be removed from inspection cuvette 1 together with the inspection liquid L (typically water). This removal of the inspection liquid L from inspection cuvette 1 on the return path is a matter of routine to avoid that particles or other unwanted matter be contained in the inspection liquid at the lens insertion station. Accordingly, inspection liquid L that has been used for inspection of soft contact lens CL is removed and inspection cuvette 1 is filled with fresh inspection liquid L prior to insertion of the next soft contact lens CL to be inspected.

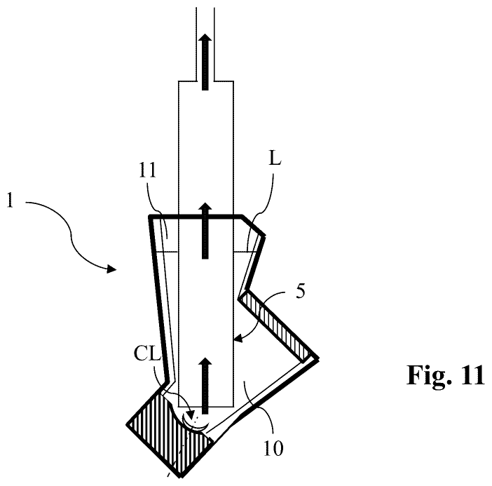

Removal of inspection liquid L from inspection cuvette 1 is typically performed with the aid of a suction tube 5 that is inserted into the interior space 10 of inspection cuvette 1 through handling channel 11 to a predetermined sucking position, as this is shown in FIG. 11. Suction tube 5 may have a larger inner diameter in order to be able to reliably suck the inspection liquid L out of inspection cuvette 1. During this removal of the inspection liquid L, soft contact lens CL that has been determined not to be in a proper transfer position is sucked out of inspection cuvette 1 together with the inspection liquid L. A suitable separator for soft contact lens CL out of the stream of inspection liquid L sucked out of inspection cuvette 1 as well as another separator for the inspection liquid L itself may be arranged between suction tube 5 and a vacuum source supplying the required suction. These components are not shown in FIG. 11 but are well-known to a person skilled in the art.

The invention has been described with embodiments. However, the invention is not limited to the embodiments described. Rather, several alternatives to the described embodiments described are possible and follow the teaching underlying the invention. The scope of protection is therefore defined by the appended claims.

1. Method of handling an ophthalmic lens, for example a contact lens such as a soft contact lens (CL), at a transfer station of a lens inspection module where the lens contained in an inspection cuvette (1) and immersed in an inspection liquid (L) is arranged at an actual position relative to a concave inner surface (140) of a bottom glass (14) of the inspection cuvette (1) for being transferred from the inspection cuvette (1) to a primary packaging container,
wherein the concave inner surface (140) of the bottom glass (14) forms a lower boundary of an interior space (10) of the inspection cuvette (1),
wherein the inspection cuvette (1) further comprises a flat top viewing glass (13) forming an upper boundary of the interior space (10) of the inspection cuvette (1), the flat top viewing glass (13) being arranged such that an optical axis (OA) running normal to the flat top viewing glass (13) runs through the center of the concave inner surface (140) of the bottom viewing glass (14),
wherein the inspection cuvette (1) is pivotally arranged between an inspection position for inspecting the lens, and a handling position in which the lens may be inserted into and removed from the interior space (10) of the inspection cuvette (1),
and wherein the inspection cuvette (1) further comprises a handling channel (11) which is connected at a first end thereof with the interior space (10) and at a second end thereof comprises a handling opening (12) allowing a transfer gripper (2) to be inserted through the handling channel (11) to a predetermined lens pick-up position above a predetermined set transfer position of the lens when the cuvette (1) is in the handling position,
the method comprising the steps of:
positioning the inspection cuvette (1) in the handling position without subsequently pivoting the inspection cuvette (1) anymore;
through the viewing glass (13) obtaining, along the optical axis (OA), an image of the lens arranged at the actual position relative to the concave inner surface (140) of the bottom glass (14);
from the so obtained image of the lens at the actual position determining a deviation of the actual position of the lens from the predetermined set transfer position;
comparing the deviation of the actual position of the lens from the predetermined set transfer position with a predetermined maximum deviation;
determining that the lens is arranged at a proper transfer position when the deviation of the actual position from the predetermined set transfer position is less than the predetermined maximum deviation,
otherwise determining that the lens is not arranged at the proper transfer position; and
in case the lens is determined to be arranged at the proper transfer position, transferring the lens from the inspection cuvette (1) to the primary packaging container,
in case the lens is determined not to be arranged at the proper transfer position, not transferring the lens from the inspection cuvette (1) to the primary packaging container.

2. Method according to claim 1, wherein in case the lens is determined to be arranged at the proper transfer position
inserting a transfer gripper (2) through the handling channel (11) to the predetermined lens pick-up position;
picking the lens up at the proper transfer position by the transfer gripper (2) to make the lens adhere to the transfer gripper (2);
removing the transfer gripper (2) with the lens adhered thereto from the inspection cuvette (1) and moving it to the primary packaging container,
releasing the lens from the transfer gripper (2) into the primary packaging container.

3. Method according to claim 1, wherein in case the lens is determined not to be arranged at the proper transfer position
leaving the lens in the inspection cuvette (1) and
removing the lens together with the inspection liquid (L) from the inspection cuvette (1) by sucking the lens and liquid (L) out of the interior space (10) of the inspection cuvette (1).

4. Method according to claim 1, wherein the deviation of the actual position of the lens from the predetermined set transfer position is determined by determining a value representative of the eccentricity (e) of the actual position of the lens relative to the predetermined set transfer position.

5. Method according to claim 4, wherein the lens is determined to be arranged at the proper transfer position in case the eccentricity (e) of the actual position of the lens relative to the predetermined set transfer position is less than a predetermined threshold eccentricity (eₜ), otherwise the lens is determined not to be at the proper transfer position.

6. Method according to claim 4, wherein the threshold eccentricity (eₜ) is determined according to the equation
$${e}_{t} = [ {r}_{L} - ( {r}_{T} + {r}_{B} ) ]$$
wherein
r_{L} denotes the radius (half the diameter) of the lens;
r_{B} denotes the radius (half the diameter) of the suction openings (220) that extend through the convex distal end (22) of the transfer gripper (2) in a direction of a central longitudinal gripper axis (21);
r_{T} denotes the radius of a circle that extends about the central longitudinal gripper axis (21) and in a plane normal thereto, with the suction openings (220) in the convex distal end (22) of the transfer gripper (2) being arranged along the said circle, and
eₜ denotes the threshold eccentricity.

7. Apparatus for handling an ophthalmic lens, for example a contact lens such as a soft contact lens (CL), at a transfer station of a lens inspection module where the lens contained in an inspection cuvette (1) and immersed in an inspection liquid (L) is arranged at an actual position relative to a concave inner surface (140) of a bottom glass (14) of the inspection cuvette (1) for being transferred from the inspection cuvette to a primary packaging container,
wherein the concave inner surface (140) of the bottom glass (14) forms a lower boundary of an interior space (10) of the inspection cuvette (1),
wherein the inspection cuvette (1) further comprises a flat top viewing glass (13) forming an upper boundary of the interior space (10) of the cuvette (1), the flat top viewing glass (13) being arranged such that an optical axis (OA) running normal to the flat top viewing glass (13) runs through the center of the concave inner surface (140) of the bottom glass (13),
wherein the inspection cuvette (1) is pivotally arranged between an inspection position for inspecting the lens, and a handling position in which the lens may be inserted into and removed from the interior space (10) of the inspection cuvette (1),
and wherein the inspection cuvette (1) further comprises a handling channel (11) which is connected at a first end thereof with the interior space (10) and at a second end thereof comprises a handling opening (12) allowing a transfer gripper (2) to be inserted through the handling channel (11) to a predetermined lens pick-up position above a predetermined set transfer position of the lens when the inspection cuvette (1) is in the handling position,
the apparatus comprising:
a camera (4) arranged along the optical axis (OA) for recording, through the viewing glass (13), an image of the lens at the actual position relative to the concave inner surface (140) of the bottom glass (14) of the inspection cuvette (1) when the inspection cuvette (1) is in the handling position and is subsequently not pivoted anymore;
a processor (40) configured to
from the image of the lens at the actual position determine a deviation of the actual position of the lens from the predetermined set transfer position of the lens;
compare the deviation of the actual position of the lens from the set transfer position with a predetermined maximum deviation;
determine that the lens is arranged at a proper transfer position when the deviation is less than the predetermined maximum deviation,
otherwise determine that the lens is not arranged at the proper transfer position, and
in case the lens is determined to be arranged at the proper transfer position, generate a signal triggering the transfer of the lens from the inspection cuvette (1) to the primary packaging container,
in case the lens is determined not to be arranged at the proper transfer position, generate a signal preventing the transfer of the lens from the inspection cuvette (1) to the primary packaging container.

8. Apparatus according to claim 7, further comprising a transfer gripper (2) arranged to be inserted into and removed from the interior space (10) of the inspection cuvette (1) through the handling channel (11) to the predetermined lens pick-up position after receipt of the signal triggering the transfer of the lens, for picking the lens up at the proper transfer position to make the lens adhere to the transfer gripper (2), for removing the lens adhered to the transfer gripper (2) from the inspection cuvette (1), for moving the transfer gripper (2) with the lens adhered thereto to the primary packaging container, and for releasing the lens from the transfer gripper (2) into the primary packaging container.

9. Apparatus according to claim 7, further comprising a suction tube (5) arranged to be inserted into the interior space (10) of the inspection cuvette (1) through the handing channel (11) to a predetermined sucking position, for sucking the inspection liquid (L) and the lens out of the inspection cuvette (1) after receipt of the signal preventing the transfer of the lens from the inspection cuvette (1) to the primary packaging container, and for sucking the inspection liquid (L) out of the inspection cuvette (1) after receipt of the signal triggering the transfer of the lens and removal of the lens from the inspection cuvette (1).

10. Apparatus according to claim 7, wherein the processor (40) is configured to determine a value representative of the eccentricity (e) of the actual position of the lens relative to the predetermined set transfer position to determine the deviation of the actual position of the lens relative to the predetermined set transfer position.

11. Apparatus according to claim 10, wherein the processor (40) is configured to determine that the lens is at the proper transfer position in case the eccentricity (e) of the actual position of the lens relative to the predetermined set transfer position is less than a predetermined threshold eccentricity (eₜ), and to otherwise determine that the lens is not at the proper transfer position.

12. Apparatus according to claim 10, wherein the processor (40) is configured to determine the threshold eccentricity (eₜ) according to the equation
$${e}_{t} = [ {r}_{L} - ( {r}_{T} + {r}_{B} ) ]$$
wherein
r_{L} denotes the radius (half the diameter) of the lens;
r_{B} denotes the radius (half the diameter) of the suction openings (220) extending through the convex distal end (22) of the transfer gripper (2) in a direction of a central longitudinal gripper axis (21);
r_{T} denotes the radius of a circle that extends about the central longitudinal gripper axis (21) and normal thereto, with the suction openings in the convex distal end of the transfer gripper (2) being arranged along the said circle, and
eₜ denotes the threshold eccentricity.
